(19) United States
(12) Patent Application Publication
(10) Pub. No.: US 2017/0295138 A1
(43) Pub. Date: Oct. 12, 2017

(54) ALIAS CORRELATION SYSTEM AND METHOD

(71) Applicant: Vishwanath Shastry, Mountain View, CA (US)

(72) Inventor: Vishwanath Shastry, Mountain View, CA (US)

(21) Appl. No.: 15/097,208

(22) Filed: Apr. 12, 2016

(51) Int. Cl. H04L 29/12; H04L 29/08

(52) U.S. Cl. CPC H04L 61/306; H04L 67/10

(57) ABSTRACT

According to one embodiment of the invention, a method for determining a personal identifier corresponding to an alias is provided. The method comprises receiving a request to provide a resource, the resource being provided from an originating party to an alias representing a receiving party. The method further comprises transmitting an inquiry for a personal identifier corresponding to the alias to a plurality of remote computers, interacting with the plurality of remote computers to provide the personal identifier corresponding to the alias, and selecting a remote computer from the plurality of remote computers using selection criteria. The method further comprises requesting the personal identifier from the selected remote computer, and receiving the personal identifier from the remote computer.

### BACKGROUND

Many situations exist in which originating parties wish to provide resources to receiving parties. However, the originating party may only have access to an alias of a receiving party, such as an e-mail address or phone number. Receiving parties are hesitant to provide their personal identifiers, which may contain personal or sensitive data such as home address information or payment credentials, to originating parties for security reasons. However, the personal identifier of the receiving party may be necessary in order for the originating party to provide a resource to the receiving party. For example, an originating party may need a home address of a receiving party to send flowers, but may only have the receiving party's phone number. In another example, an originating party may need the financial account information of a receiving party in order to transfer money for the sale of an item, but may only have the receiving party's e-mail address.

Embodiments of the invention address these and other problems, individually and collectively.

### SUMMARY

Embodiments of the invention are directed to systems and methods of determining a personal identifier corresponding to an alias of a receiving party, such that an originating party can provide a resource to the receiving party when only the alias of the receiving party is known to the originating party.

One embodiment of the invention is directed to a method. The method comprises receiving a request to provide a resource, the resource being provided from an originating party to an alias representing a receiving party. The method further comprises transmitting an inquiry for a personal identifier corresponding to the alias to a plurality of remote computers, interacting with the plurality of remote computers to provide the personal identifier corresponding to the alias, and selecting a remote computer from the plurality of remote computers using selection criteria. The method further comprises requesting the personal identifier from the selected remote computer, and receiving the personal identifier from the selected remote computer.

Another embodiment of the invention is directed to another method. The method comprises making a request to a server computer to provide a resource to an alias representing a receiving party, wherein the server computer thereafter transmits an inquiry for a personal identifier corresponding to the alias to a plurality of remote computers. The method further comprises receiving parameters associated with each of the plurality of remote computers having the personal identifier corresponding to the alias, applying selection criteria to the received parameters to select a remote computer from the plurality of remote computers, and transmitting the selection to the server computer. The server computer thereafter requests and receives the personal identifier from the selected remote computer.

Other embodiments of the invention are directed to a server comprising a processor and a memory coupled to the processor. The memory stores instructions, which when executed by the processor, cause the server to perform the operations of the disclosed methods.

These and other embodiments of the invention are described in further detail below.

### BRIEF DESCRIPTION OF THE DRAWINGS

FIG. 1 is a block diagram showing a system according to an embodiment of the present invention.

FIG. 2A shows a block diagram of an alias correlation system according to an embodiment of the present invention.

FIG. 2B shows a block diagram of a transaction processing computer according to an embodiment of the present invention.

FIG. 3 shows a flow diagram illustrating a method for alias correlation according to an embodiment of the present invention.

FIG. 4 shows a flow diagram illustrating another method for alias correlation according to an embodiment of the present invention.

### DETAILED DESCRIPTION

Embodiments of the present invention are directed to systems and methods for obtaining a personal identifier corresponding to an alias, such that a resource may be provided from an originating party to a receiving party using only the alias. Embodiments of the present invention may be used to determine a personal identifier of a receiving party, without disclosing the personal identifier to the originating party. In one example, embodiments of the present invention may be used in transaction processing systems. Such embodiments may involve transactions between users and merchants, such as payment transactions.

Prior to discussing specific embodiments of the invention, some terms may be described in detail.

A “resource” may comprise any tangible or intangible asset that can be transferred from one person or entity to another. Examples of resources include physical items (e.g., computers, real estate, furniture, clothing), money, representations of money (e.g., checks, money orders, stocks, bonds), and data.

An “alias” may comprise any name, word, or character(s) representing or associated with a person or entity. Examples of aliases include names, user names, e-mail addresses, phone numbers, physical addresses, fax numbers, account numbers, or any other information indicative of or associated with a person or entity.

A “personal identifier” may comprise any information establishing the identity of a person. In one embodiment, a personal identifier may be any information used to provide a resource to a person or entity. The information may include letters, numbers, words, symbols, graphics, etc. Examples of personal identifiers include e-mail addresses, phone numbers, physical addresses, fax numbers, account numbers, and payment credentials.

“Parameters” may be numbers or other measurable factors. Examples of parameters include features, incentives and prices.

A “communication device” may comprise any suitable electronic device that may be operated by a user, which may also provide local communication capabilities (e.g., via Bluetooth™ or RF technologies) and/or remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. A “portable communication device” is a communication device that may be transported by a user. Examples of portable communication devices include mobile phones (e.g., cellular phones), PDAs, tablet computers, net books, laptop computers, personal music players, handheld specialized readers, etc. Further examples of portable communication devices include wearable devices, such as smart watches, fitness bands, ankle bracelets, rings, earrings, etc., as well as automobiles with remote communication capabilities. A portable communication device may comprise any suitable hardware and/or software for performing such functions, and may also include multiple devices or components (e.g., when a device has remote access to a network by tethering to another device—i.e., using the other device as a modem—both devices taken together may be considered a single portable communication device).

“Payment credentials” may include any suitable information associated with an account (e.g. a payment account and/or payment device associated with the account). Such information may be directly related to the account or may be derived from information related to the account. Examples of account information may include an “account identifier” such as a PAN (primary account number or “account number”), user name, expiration date, CVV (card verification value), dCVV (dynamic card verification value), CVV2 (card verification value 2), CVC3 card verification values, etc. An example of a PAN is a 16-digit number, such as “4147 0900 0000 1234.” Payment credentials may be any information that identifies or is associated with a payment account. Payment credentials may be provided in order to make a payment from a payment account. Payment credentials can also include a user name, an expiration date, a gift card number or code, a payment token, and any other suitable information. In some embodiments, payment credentials may be considered private or sensitive information.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

An “authorizing entity” may be an entity that authorizes a request. Examples of an authorizing entity may be an issuer, a governmental agency, a document repository, an access administrator, etc. An authorizing entity can be identified by an “authorizing entity identifier”, which may be a string of characters or take any other suitable form. An example of an authorizing entity identifier is an issuer BIN (bank identification number).

An “issuer” may typically refer to a business entity (e.g., a bank) that maintains an account for a user. An issuer may also issue payment credentials stored on communication device, such as a cellular telephone, smart card, tablet, or laptop to the consumer. An issuer can be identified by an issuer identifier, such as a BIN. In some embodiments, a PAN can comprise a BIN in addition to other characters. For example, the first four to six digits of a PAN may be the BIN. Thus, a PAN can indicate an associated issuer. In some embodiments, a BIN can also identify a transaction processor.

An “authorization request message” may be an electronic message that requests authorization for a transaction. In some embodiments, it is sent to a transaction processing computer and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “user information” including, by way of example only: a service code, a CVV (card verification value), a dCVV (dynamic card verification value), a PAN (primary account number or “account number”), a payment token, a user name, an expiration date, etc. An authorization request message may also comprise “transaction information,” such as any information associated with a current transaction, such as the transaction amount, merchant identifier, merchant location, acquirer bank identification number (BIN), card acceptor ID, information identifying items being purchased, etc., as well as any other information that may be utilized in determining whether to identify and/or authorize a transaction. Other examples of transaction information are provided above.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g. POS equipment) that indicates approval of the transaction. The code may serve as proof of authorization. As noted above, in some embodiments, a transaction processing computer may generate or forward the authorization response message to the merchant.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “wallet” may include a device or software which can store user profile information, payment information, bank account information, and/or the like. An electronic wallet can be used in a variety of transactions. Such transactions may include, but are not limited to, eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like.

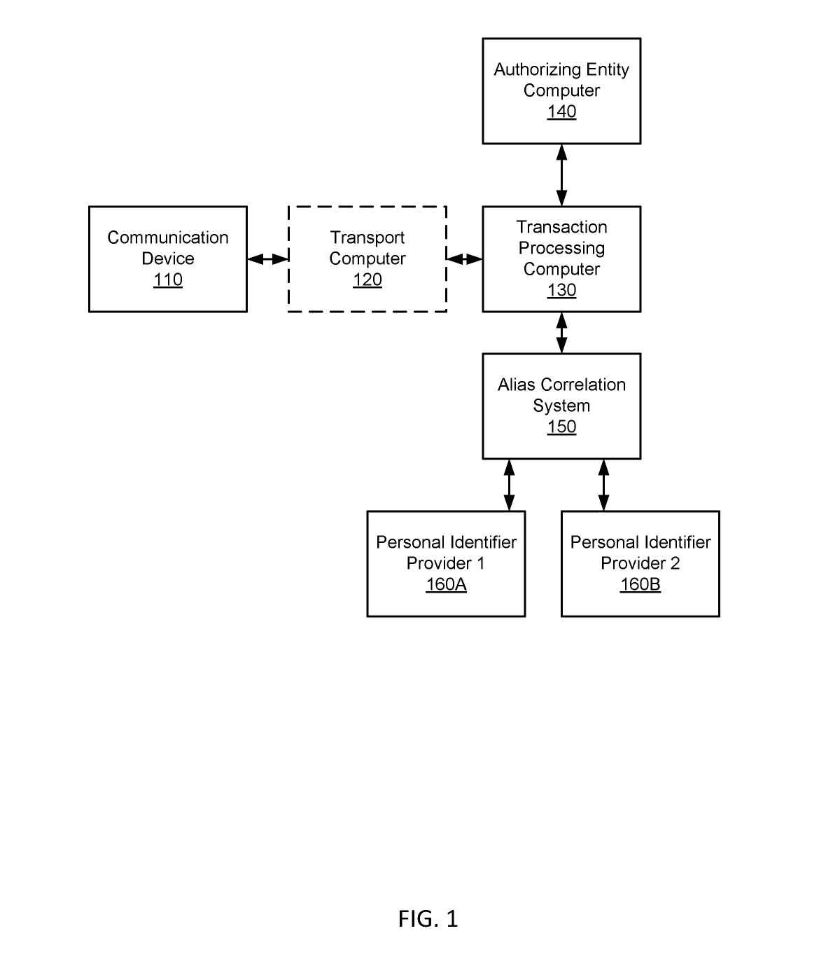

FIG. 1 is a block diagram showing a system according to an embodiment of the present invention. The system comprises a communication device 110. The communication device 110 is operated by a originating party in one embodiment. A communication device 110 may be a portable communication device in one embodiment. In another embodiment, communication device 110 is not necessarily portable (e.g., a computer workstation that is not intended to be easily transported).

The system further comprises an optional transport computer 120, a transaction processing computer 130, an authorizing entity computer 140, an alias correlation system 150, a personal identifier provider 1 160A, and a personal identifier provider 2 160B, each of which may be embodied on one or more computers. The communication device 110, the optional transport computer 120, the transaction processing computer 130, the authorizing entity computer 140, the alias correlation system 150, the personal identifier provider 1 160A, and the personal identifier provider 2 160B may all be in operative communication with each other through any suitable communication channel or communications network. Suitable communications networks may be any one and/or a combination of the following: a direct interconnection, the Internet, a Local Area Network (LAN), a Metropolitan Area Network (MAN), an Operating Missions as Nodes on the Internet (OMNI), a secured custom connection, a Wide Area Network (WAN), a wireless network (e.g., employing protocols such as, but not limited to, a Wireless Application Protocol (WAP), I-mode, and/or the like), and/or the like.

Messages between the computers, networks, and devices may be transmitted using a secure communications protocol such as, but not limited to, File Transfer Protocol (FTP), HyperText Transfer Protocol (HTTP), Secure HyperText Transfer Protocol (HTTPS), Secure Socket Layer (SSL), ISO (e.g., ISO 8583), and/or the like. Alternatively or additionally, messages between the computers, networks, and devices may be encrypted using keys to secure communication of data.

The originating party may be able to use the communication device 110 to make requests to provide a resource to an alias representing a receiving party. In one embodiment, the resource may be a financial transfer. In this embodiment, the originating party may be associated with the communication device 110 and a payment account. The originating party may be able to use the communication device 110 to request a transfer of funds from the payment account to an alias representing the receiving party. The communication device 110 may store information associated with the originating party and/or the payment account. The communication device 110 may provide this information to the optional transport computer 120, or directly to the transaction processing computer 130 when requesting the financial transfer. The communication device 110 may also act through a different financial institution computer (e.g., an issuer computer) to provide this information to the transaction processing computer 130. The transport computer 120 may be an acquirer computer. The transport computer 120 may be able to forward the request to transfer the funds to the alias from the originating party to the transaction processing computer 130.

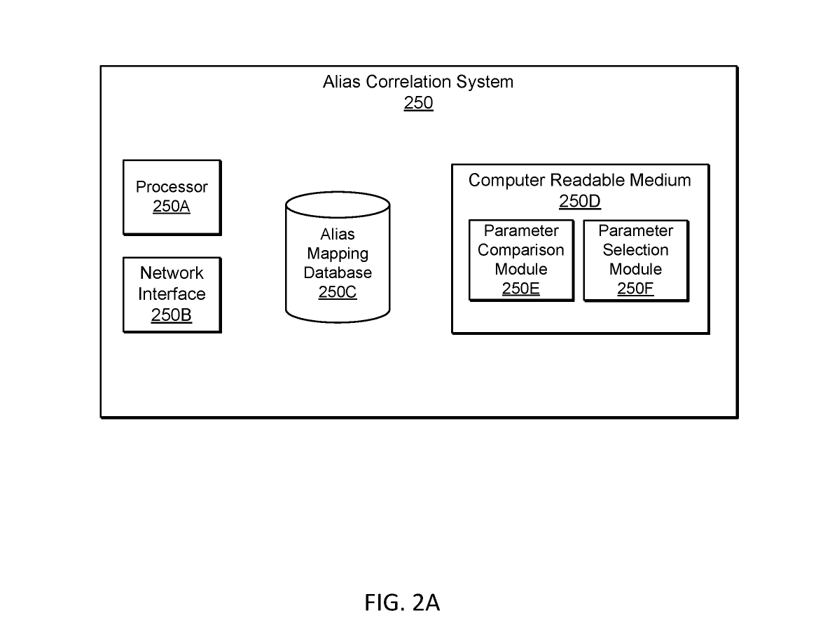

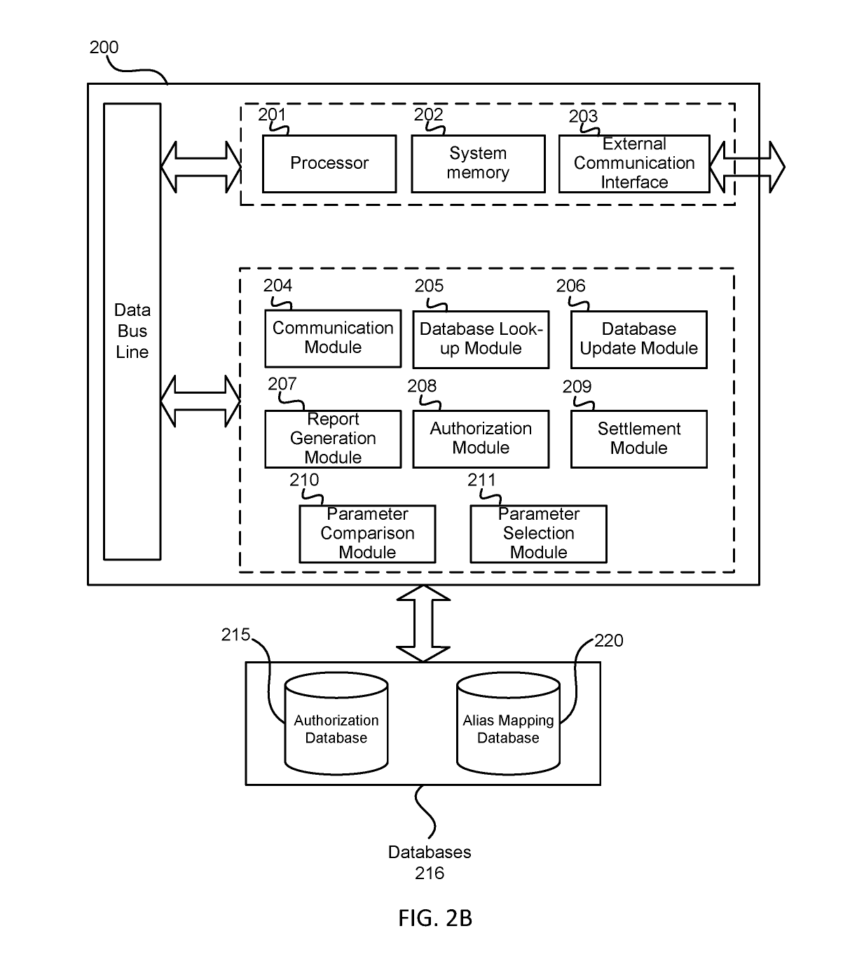

The transaction processing computer 130 may be disposed between (in an operational sense) the transport computer 120 and the authorizing entity computer 140. The transaction processing computer 130 may include data processing subsystems, networks, and operations used to support and deliver authorization services, exception file services, and clearing and settlement services. For example, the transaction processing computer 130 may comprise a server coupled to a network interface (e.g., by an external communication interface), and databases of information. The transaction processing computer 130 may be representative of a transaction processing network. An exemplary transaction processing computer may include VisaNet™. Transaction processing networks such as VisaNet™ are able to process credit card transactions, debit card transactions, and other types of transactions. VisaNet™, in particular, includes a VIP system (Visa Integrated Payments system), which processes authorization requests and a Base II system which performs clearing and settlement services. The transaction processing computer 130 may use any suitable wired or wireless network, including the Internet. An example of a transaction processing computer is described herein with respect to FIG. 2B.

The transaction processing computer 130, the transport computer 120, and the authorizing entity computer 140 may operate suitable routing tables to route authorization request messages using payment credentials or account identifiers. The authorizing entity computer 140 may issue and manage a payment account and associated payment devices of the originating party. The authorizing entity computer 140 may be able to authorize transactions, such as payment transfers between the originating party and the receiving party.

In one embodiment, the transaction processing computer 130 is also coupled to an alias correlation system 150. An example of an alias correlation system is described herein with respect to FIG. 2A. The alias correlation system 150 transmits inquiries for personal identifiers corresponding to aliases to personal identifier provider 1 160A and personal identifier provider 2 160B.

In the embodiment in which the resource is money, the alias correlation system 150 can transmit inquiries for a payment account number associated with the alias of the receiving party to personal identifier provider 1 160A and personal identifier provider 2 160B. Each of these entities may operate computers, which can be programmed to perform the functions described herein. Personal identifier provider 1 160A and personal identifier provider 2 160B provide parameters to the alias correlation system 150 to aid the alias correlation system 150 in selection of one of the personal identifier providers. For example, personal identifier provider 1 160A and personal identifier provider 2 1606 may provide prices for providing the personal identifiers associated with the alias. Although two personal identifier providers are illustrated, it is contemplated that any number of personal identifier providers may be present in embodiments of the invention.

Although FIG. 1 illustrates the alias correlation system 150 as being separate and distinct from the transaction processing computer 130, in other embodiments, the alias correlation system 150 can be incorporated into the transaction processing computer 130.

An example of an alias correlation system 250, according to an embodiment of the present invention, is shown in FIG. 2A. The alias correlation system 250 comprises a processor 250A, a network interface 250B, an alias mapping database 250C, and a computer readable medium 250D.

The computer readable medium 250D may comprise a number of software modules including a parameter comparison module 250E and a parameter selection module 250F. The computer readable medium 250D may also comprise code, executable by the processor 250A for implementing a method comprising receiving a request to provide a resource, the resource being provided from an originating party to an alias representing a receiving party, transmitting an inquiry for a personal identifier corresponding to the alias to a plurality of remote computers corresponding to personal identifier providers, interacting with the plurality of remote computers to provide the personal identifier corresponding to the alias, selecting a remote computer from the plurality of remote computers using selection criteria, requesting the personal identifier from the selected remote computer, and receiving the personal identifier from the selected remote computer.

The parameter comparison module 250E may comprise code that causes the processor 250A to receive and compare parameters from personal identifier providers. The parameters may be stored in association with the alias and the personal identifier provider in the alias mapping database 250C. The parameter selection module 250F may comprise code that causes the processor 250A to apply selection criteria to the parameters to select one parameter and its associated personal identifier provider to provide the personal identifier associated with the alias. The parameters may be numbers or other measurable factors. In one embodiment, the parameters are costs or prices for providing the personal identifier. The selection criteria may be based on any factor. For example, the selection criteria may specify to select the personal identifier provider providing the personal identifier for the lowest cost.

An example of a transaction processing computer 200 is shown in FIG. 2B. The exemplary transaction processing computer 200 is illustrated as comprising a plurality of hardware and software modules 201-211. However, it should be appreciated that this is provided for illustration purposes only, and each of the modules and associated functionality may be provided and/or performed by the same or different components. That is, transaction processing computer 200 may, for example, perform some of the relevant functions and steps described herein through the use of any suitable combination of software instructions and/or hardware configurations. It should be noted that although FIG. 2B illustrates all of the modules located on a single device, the disclosure is not meant to be so limited. Moreover, a system for implementing the functionality described herein may have additional components or less than all of these components.

The transaction processing computer 200 is shown as comprising a processor 201, system memory 202 (which may comprise any combination of volatile and/or non-volatile memory such as, for example, buffer memory, RAM, DRAM, ROM, flash, or any other suitable memory device), and an external communication interface 203. Moreover, one or more of the modules 204-211 may be disposed within one or more of the components of the system memory 202, or may be disposed externally. The processor 201, system memory 202 and/or external communication interface 203 may be used in conjunction with any of the modules described below to provide a desired functionality. Some exemplary modules and related functionality may be as follows.

The communication module 204 may be programmed to receive and generate electronic messages comprising information transmitted through the transaction processing computer 200 to or from any of the entities shown in FIG. 1. When an electronic message is received by the transaction processing computer 200 via external communication interface 203, it may be passed to the communication module 204. The communication module 204, in conjunction with the processor 201, may identify and parse the relevant data based on a particular messaging protocol used in the transaction processing computer 200. The received information may comprise, for instance, identification information, transaction information, and/or any other information that the transaction processing computer 200 may utilize in authorizing a financial transaction or performing a settlement and clearing procedure. The communication module 204, in conjunction with the processor 201, may then transmit any received information to an appropriate module within the transaction processing computer 200 (e.g., via a system bus line). The communication module 204, in conjunction with the processor 201, may also receive information from one or more of the modules in transaction processing computer 200 and generate an electronic message in an appropriate data format in conformance with a transmission protocol so that the message may be sent to one or more components within the system of FIG. 1. The electronic message may then be passed to the external communication interface 203 for transmission. The electronic message may, for example, comprise an authorization response message or may be an authorization request message to be transmitted or forwarded to an issuer.

The database look-up module 205 may be programmed to cause the processor 201 to perform some or all of the functionality associated with retrieving information from one or more databases 216. In this regard, the database look-up module 205, in conjunction with the processor 201, may receive requests from one or more of the modules of transaction processing computer 200 (such as communication module 204, authorization module 208, or settlement module 209) for information that may be stored in one or more of the databases 216. The database look-up module 205, in conjunction with the processor 201, may then determine and a query an appropriate database. The database update module 206 may be programmed or configured to maintain and update the databases 216, such as authorization database 215 and alias mapping database 220. In this regard, the database update module 206, in conjunction with the processor 201, may receive information about a user, financial institution, a payment device, and/or current or past transaction information from one of the modules discussed herein. This information may then be stored in the appropriate location in the databases 216 using any suitable storage process.

The report generation module 207 may be programmed to perform some or all of the functionality associated with generating a report regarding a user, an account, a transaction or transactions, or any other entity or category of information with regard to system of FIG. 1.

The authorization module 208 may be programmed to perform some or all the functionality associated with authorizing a financial transaction associated with an authorization request message.

As shown in FIG. 2B, in an embodiment in which the functions of the alias correlation system are incorporated into the transaction processing computer 200, the transaction processing computer 200 may further include a parameter comparison module 210 and a parameter selection module 211. The parameter comparison module 210 may comprise code that causes the processor 201 to receive and compare parameters from personal identifier providers. The parameter selection module 211 may comprise code that causes the processor 201 to apply selection criteria to the parameters to select one parameter and its associated personal identifier provider to provide the personal identifier associated with the alias. The parameters may be numbers or other measurable factors. In one embodiment, the parameters are costs for providing the personal identifier. In another embodiment, the parameters may relate to the reliability, authenticity, or speed of delivery of the personal identifier. The selection criteria may be based on any number of factors. For example, the selection criteria may specify to select the personal identifier provider providing the personal identifier for the lowest cost. In other embodiments, the selection criteria may relate to the highest reliability, authenticity, or speed of delivery.

The transaction processing computer 200 may include one or more databases 216, such as authorization database 215 and alias mapping database 220. Each of the databases shown in this example may comprise more than one database, and may be located in the same location or at different locations. The authorization database 215 may contain information related to a payment device and/or a payment account, as well as any other suitable information (such as transaction information) associated with the payment account. The alias mapping database 220 may store parameters in association with the alias and the personal identifier provider in the alias mapping database 220 for future reference, as described further herein.

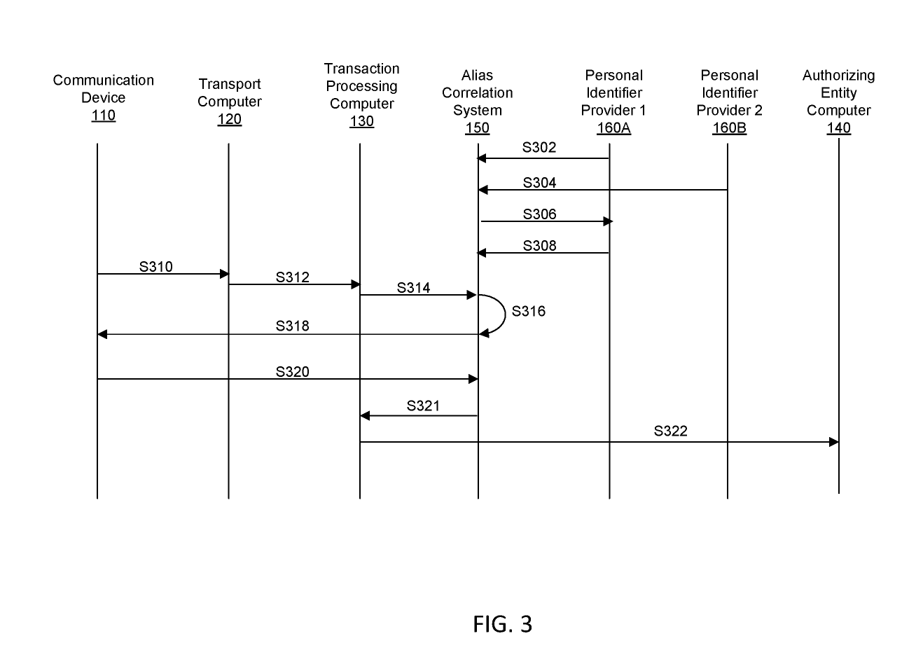

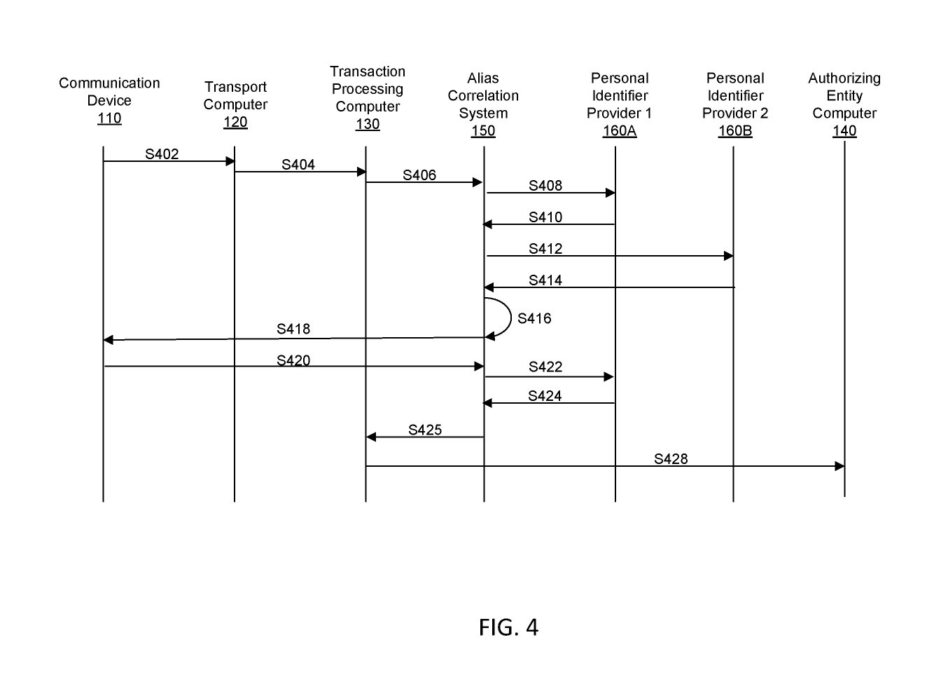

FIGS. 3 and 4 illustrate methods of determining personal identifiers corresponding to an alias according to embodiments of the invention. In the embodiment illustrated in FIG. 3, each of the personal identifier provider 1 160A and the personal identifier provider 2 1606 provides a list of aliases for which personal identifiers are respectively known, prior to receiving a request for a particular alias.

At step S302, personal identifier provider 1 160A provides a list of aliases for which personal identifier provider 1 160A has the corresponding personal identifier, as well as parameters related to providing each personal identifier, to alias correlation system 150. At step S304, personal identifier provider 2 1606 provides a list of aliases for which personal identifier provider 2 1606 has the corresponding personal identifier, as well as parameters related to providing each personal identifier, to alias correlation system 150. In some embodiments, a particular alias may correspond to more than one personal identifier, and/or a personal identifier may correspond to more than one alias.

Illustratively, in one embodiment, personal identifier provider 1 and personal identifier provider 2 are wallet providers. In this embodiment, the alias may be an e-mail address, and the personal identifier may be a financial account number. The parameters may be a cost or rate associated with providing the personal identifier associated with each alias. For example, personal identifier provider 1 160A and personal identifier provider 2 1606 may both provide lists including a particular alias (e.g., your.name@gmail.com), an associated personal identifier (e.g., account number 1111 1111 1111 1111), and a cost (e.g., $0.05 and $0.04, respectively). In some cases, the personal identifiers held by the different personal identifier providers are different, and in some cases they may be the same. In such cases, the personal identifier providers may all have the same alias. In another example, only one of personal identifier provider 1 160A and personal identifier provider 2 160B may have a particular alias to personal identifier mapping.

The parameters provided by personal identifier provider 1 160A and personal identifier provider 2 1606 may be the same or different. If they are different, e.g., if personal identifier provider 2 160B provides a more attractive parameter than personal identifier provider 1 160A, alias correlation system 150 may provide personal identifier provider 1 160A with the parameter received from personal identifier provider 2 1606 at step S306, to give personal identifier provider 1 160A the chance to provide a still more attractive parameter. For example, personal identifier provider 1 160A may offer a price of $0.05 to provide the credit card account number (e.g., 4444 1111 2222 3533) corresponding to a particular alias, such as an e-mail address (e.g., joe@gmail.com). Personal identifier provider 2 160B may offer a price of $0.04 to provide the same account number (e.g., 4444 1111 2222 3533) corresponding to that alias (e.g., joe@gmail.com). The alias correlation system 150 can alert the personal identifier provider 1 160A of the $0.04 offer from personal identifier provider 2 160B to give personal identifier provider 1 160A a chance to modify its offer to provide the credit card account number.

At step S308, personal identifier provider 1 160A may provide a still better parameter than that offered by personal identifier provider 2 160B to the alias correlation system 150. For example, personal identifier provider 1 160A may make an offer of $0.03 to provide the personal identifier. Although not illustrated in FIG. 3, it is contemplated that the alias correlation system 150 may go through multiple rounds of collecting parameters and negotiating the best parameter for providing the personal identifier. Thus, steps S302-S308 may resemble an auction or bidding process. The alias, parameter, and/or personal identifier may be stored in an alias mapping database.

At some point thereafter, at step S310, an originating party via a communication device 110 sends a request message to transport computer 120 to provide a resource to an alias representing a receiving party. In one example, the resource may be money and the alias may be an e-mail address associated with the receiving party. The request message may include the resource amount, the originating party's payment account number (i.e., the account will provide the resource), and the alias. At step S312, the transport computer 120 provides the request to the transaction processing computer 130. At this time, the transaction processing computer 130 may temporarily store the originating party's payment account number. At step S314, the transaction processing computer 130 transmits an inquiry message to alias correlation system 150 to see if a personal identifier relating to that alias is available. The inquiry message can include the alias.

At step S316, the alias correlation system 150 searches its database and determines that personal identifier provider 1 160A and personal identifier provider 2 160B both have the personal identifier associated with that alias. The alias correlation system 150 further determines that personal identifier provider 1 160A has provided the most attractive parameter (e.g., the lowest price). In one embodiment, at step S318, the alias correlation system 150 provides that parameter to communication device 110 for acceptance. At step S320, the communication device 110 accepts the parameter and a message is sent to the alias correlation system 150 indicating the same. Steps S318 and S320 are optional as the alias correlation system 150 could automatically select the most attractive parameter by itself, without consulting with the originator.

At step S321, once the alias correlation system 150 receives the alias, it may determine the personal identifier, which may be an account number for the receiving party, and may sent it in a response message to the transaction processing computer 130 to facilitate the resource being provided to the receiving party via the personal identifier. Transaction identifiers may be present in the message that is sent to alias correlation system 150 in step S314 as well as the message to the transaction processing computer 130 in step S321 so that the transaction processing computer 130 can determine that the messages are part of the same transaction. Once the transaction processing computer 130 has both the account number of the originating party and the personal identifier (e.g., the account number) of the receiving party, it can then initiate the transfer of money from the originating party's account to the account associated with the receiving party's personal identifier. At step S322, the transaction processing computer 130 can forward a request to an authorizing entity computer 140 associated with the originating party's account to transfer funds from the originating party's account to the receiving party's account, which may be with a different institution (e.g., a different financial institution).

The transfer of funds from the originating party's account to the receiving party's account can happen in any suitable manner. In some embodiments, the transaction processing computer 130 may send an original credit message to the receiving party's financial institution and may also send an account funding transaction message to the authorizing entity computer 140 associated with the originating party. Each message will indicate the proper amount to be credited and debited to the correct accounts, and the transaction processing computer 130 may facilitate a clearing and settlement process at a subsequent time. In another example, both of the originating party's account number and the receiving party's personal identifier may be sent to the authorizing entity computer 140 associated with the originating party. The authorizing entity computer 140 then has sufficient information to transfer the requested money through a wire or ACH (automated clearing house) transfer to the receiving party's personal identifier (e.g., credit, debit, or demand account). In addition, during the funds transfer, the transaction processing computer 130 may further facilitate the payment of any agreed upon fees, such as the payment of the quoted fee (i.e., the parameter) from the originating party to the personal identifier provider 1.

As noted above, although shown and described as being separate from the transaction processing computer 130, it is contemplated that the alias correlation system 150 may be incorporated into the transaction processing computer 130. Further, it is contemplated that the transport computer 120 is not required in some embodiments.

In the embodiment illustrated in FIG. 4, the personal identifier provider 1 160A and the personal identifier provider 2 160B determine whether personal identifier associated with aliases are respectively known in real time, after receiving a request for a particular alias.

At step S402, an originating party via a communication device 110 sends a request message to transport computer 120 to provide a resource to an alias representing a receiving party. In one example, the resource may be money and the alias may be an e-mail address associated with the receiving party. At step S404, the transport computer 120 provides the request message to the transaction processing computer 130. The request message may also comprise the resource amount, an account number of the originating party, and the alias of the receiving party. The resource amount and the originating party's account number may be temporarily stored by the transaction processing computer 130. At step S406, the transaction processing computer 130 then transmits an inquiry message including the received alias to alias correlation system 150 to see if a personal identifier relating to that alias is available.

At step S408, the alias correlation system 150 queries personal identifier provider 1 160A to determine whether a personal identifier relating to the alias is available. At step S410, the personal identifier provider 1 160A responds with a parameter for providing the personal identifier. Similarly, at step S412, the alias correlation system 150 queries personal identifier provider 2 160B to determine whether a personal identifier relating to the alias is available. At step S414, the personal identifier provider 2 1606 responds with a parameter for providing the personal identifier.

In one embodiment, personal identifier provider 1 and personal identifier provider 2 are wallet providers. In this embodiment, the alias may be an e-mail address, and the personal identifier may be a financial account number associated with the receiving party. The parameters may be a cost or rate associated with providing the personal identifier associated with each alias.

At step S416, the alias correlation system 150 compares the parameters received from personal identifier provider 1 160A and personal identifier provider 2 160B, and determines that personal identifier provider 1 160A has provided the most identifier parameter (e.g., the lowest price). The parameters provided by personal identifier provider 1 160A and personal identifier provider 2 1606 may be the same or different. If they are different, e.g., if personal identifier provider 1 160A provides a more attractive parameter than personal identifier provider 2 160B, alias correlation system 150 may provide personal identifier provider 2 1606 with the parameter received from personal identifier provider 1 160A (not shown), to give personal identifier provider 2 160B the chance to provide a still more attractive parameter.

For example, the personal identifier provider 1 160A may offer a rate of $0.07 to provide the account number corresponding to a particular alias. Personal identifier provider 2 160B may offer a rate of $0.08 to provide the same account number corresponding to that alias. In one embodiment, the alias correlation system 150 can alert the personal identifier provider 2 1606 of the $0.07 offer from personal identifier provider 1 160A (not shown). Although not illustrated in FIG. 4, it is contemplated that the alias correlation system 150 may go through multiple rounds of collecting parameters and negotiating the best parameter for providing the personal identifier. Thus, steps S408-S414 may resemble an auction or bidding process.

In one embodiment, after selecting personal identifier provider 1 160A, the alias correlation system 150 further optionally provides that parameter to communication device 110 for acceptance at step S418. At step S420, after receiving the parameters, the communication device 110 accepts the parameter. At step S422, the alias correlation system 150 requests the personal identifier from the personal identifier provider 1 160A, and receives it at step S424. At step S425, the personal identifier is forwarded from the alias correlation system 150 in a message to the transaction processing computer 130 to facilitate the resource being provided to the receiving party via the personal identifier. At this point, the transaction processing computer 130 has the originating party's account number, the personal identifier (e.g., the account number) of the receiving party, and the resource amount.

At step S428, the transaction processing computer 130 can forward a request to an authorizing entity computer 140 associated with the originating party's account to transfer funds from the originating party's account to the receiving party's account, which may be with a different institution (e.g., a different financial institution).

The transfer of funds from the originating party's account to the receiving party's account can happen in any suitable manner. In some embodiments, the transaction processing computer 130 may send an original credit message to the receiving party's financial institution and may also send an account funding transaction message to the authorizing entity computer 140 associated with the originating party. Each message will indicate the proper amount to be credited and debited to the correct accounts, and the transaction processing computer 130 may facilitate a clearing and settlement process at a subsequent time. In another example, both of the originating party's account number and the receiving party's personal identifier may be sent to the authorizing entity computer 140 associated with the originating party. The authorizing entity computer 140 then has sufficient information to transfer the requested money through a wire or ACH (automated clearing house) transfer to the receiving party's personal identifier (e.g., credit, debit, or demand account). In addition, during the funds transfer, the transaction processing computer 130 may further facilitate the payment of any agreed upon fees, such as the payment of the quoted fee (i.e., the parameter) from the originating party to the personal identifier provider 1. Additional methods for transferring money between different accounts can be found in U.S. Published Patent Application No. 2012/0066131 and U.S. Published Patent Application No. 2013/0191284, which are herein incorporated by reference in their entirety.

Embodiments of the present invention provide a number of advantages. For example, embodiments of the present invention allow an originating party to provide a resource (e.g., a payment) to a receiving party without the disclosure of the receiving party's potentially sensitive personal identifier(s) (e.g., an account number). This enhances the security of the receiving party. Further, certain embodiments of the present invention allow the originating party to provide the receiving party with the resource at the lowest possible cost to the originating party.

The various participants and elements described herein may operate one or more computer apparatuses to facilitate the functions described herein. Any of the elements in the above-described FIGS. 1-3, including any servers or databases, may use any suitable number of subsystems to facilitate the functions described herein.

Such subsystems or components are interconnected via a system bus. Subsystems may include a printer, keyboard, fixed disk (or other memory comprising computer readable media), monitor, which is coupled to display adapter, and others. Peripherals and input/output (I/O) devices, which couple to an I/O controller (which can be a processor or other suitable controller), can be connected to the computer system by any number of means known in the art, such as a serial port. For example, a serial port or an external interface can be used to connect the computer apparatus to a wide area network such as the Internet, a mouse input device, or a scanner. The interconnection via the system bus allows the central processor to communicate with each subsystem and to control the execution of instructions from system memory or the fixed disk, as well as the exchange of information between subsystems. The system memory and/or the fixed disk may embody a computer readable medium.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A server comprising:
a processor; and
a memory coupled to the processor, the memory storing instructions, which when executed by the processor, cause the server to perform operations including:
receiving a request to provide a resource, the resource being provided from an originating party to an alias representing a receiving party;
transmitting an inquiry for a personal identifier corresponding to the alias to a plurality of remote computers;
interacting with the plurality of remote computers to provide the personal identifier corresponding to the alias;
selecting a remote computer from the plurality of remote computers using selection criteria;
requesting the personal identifier from the selected remote computer; and
receiving the personal identifier from the remote computer.

2. The server of claim 1, wherein the alias is at least one of an e-mail address, phone number, and name.

3. The server of claim 1, wherein interacting with the plurality of remote computers to provide the personal identifier corresponding to the alias comprises:
receiving a first parameter from a first remote computer of the plurality of remote computers;
receiving a second parameter from a second remote computer of the plurality of remote computers; and
providing the second parameter to the first remote computer.

4. The server of claim 3, wherein interacting with the plurality of remote computers to provide the personal identifier corresponding to the alias further comprises:
receiving a third parameter from the first remote computer.

5. The server of claim 3, wherein after selecting the remote computer from the plurality of remote computers using selection criteria, and before requesting the personal identifier from the selected remote computer, the operations further include:
providing at least one of the first parameter and the second parameter to the originating party; and
receiving acceptance of one of the first parameter and the second parameter from the originating party.

6. The server of claim 1, wherein the operations further include:
facilitating the resource being provided to the receiving party via the personal identifier.

7. A method comprising:
receiving, by a computer, a request to provide a resource, the resource being provided from an originating party to an alias representing a receiving party;
transmitting, by the computer, an inquiry for a personal identifier corresponding to the alias to a plurality of remote computers;
interacting, by the computer, with the plurality of remote computers to provide the personal identifier corresponding to the alias;
selecting, by the computer, a remote computer from the plurality of remote computers using selection criteria;
requesting, by the computer, the personal identifier from the selected remote computer; and
receiving, by the computer, the personal identifier from the selected remote computer.

8. The method of claim 7, wherein the alias is at least one of an e-mail address, phone number, and name.

9. The method of claim 7, wherein interacting with the plurality of remote computers to provide the personal identifier corresponding to the alias comprises:
receiving a first parameter from a first remote computer of the plurality of remote computers;
receiving a second parameter from a second remote computer of the plurality of remote computers; and
providing the second parameter to the first remote computer.

10. The method of claim 9, wherein interacting with the plurality of remote computers to provide the personal identifier corresponding to the alias further comprises:
receiving a third parameter from the first remote computer.

11. The method of claim 9, further comprising, after selecting the remote computer from the plurality of remote computer using the selection criteria, and before requesting the personal identifier from the selected remote computer:
providing at least one of the first parameter and the second parameter to the originating party; and
receiving acceptance of one of the first parameter and the second parameter from the originating party.

12. The method of claim 7, further comprising:
facilitating the resource being provided to the receiving party via the personal identifier.

13. A method comprising:
making a request to a server computer to provide a resource to an alias representing a receiving party, wherein the server computer thereafter transmits an inquiry for a personal identifier corresponding to the alias to a plurality of remote computers;
receiving parameters associated with each of the plurality of remote computers having the personal identifier corresponding to the alias;
applying selection criteria to the received parameters to select a remote computer from the plurality of remote computers; and
transmitting the selection to the server computer,
wherein the server computer thereafter requests and receives the personal identifier from the selected remote computer.

14. The method of claim 13, wherein the alias is at least one of an e-mail address, phone number, and name.

15. The method of claim 13, wherein after the server computer requests and receives the personal identifier from the selected remote computer, the server computer facilitates providing the resource to the receiving party via the personal identifier.
